(19) United States
(12) Patent Application Publication
(10) Pub. No.: US 2018/0066179 A1
(43) Pub. Date: Mar. 8, 2018

(54) FLUID CREATING A FRACTURE HAVING A BOTTOM PORTION OF REDUCED PERMEABILITY AND A TOP HAVING A HIGHER PERMEABILITY

(71) Applicant: Halliburton Energy Services, Inc., Houston, TX (US)

(72) Inventors: Philip D. NGUYEN, Houston, TX (US); Walter T. STEPHENS, Houston, TX (US)

(21) Appl. No.: 15/560,263

(22) PCT Filed: Jun. 14, 2015
(86) PCT No.: PCT/US2015/035719

§ 371 Date: Sep. 21, 2017

(51) Int. Cl. C09K 8/80; C09K 8/62; E21B 43/267

(52) U.S. Cl. CPC C09K 8/80; E21B 43/267; C09K 8/62

(57) ABSTRACT

A method of fracturing a subterranean formation comprising: introducing a fracturing fluid into the subterranean formation to create or enhance a fracture in the subterranean formation, and wherein the fracture comprises a bottom portion and a top portion; and introducing a treatment fluid into the fracture after introduction of the fracturing fluid, wherein the treatment fluid comprises: a base fluid; and proppant, wherein a first portion of the proppant has a property that is different from a second portion of the proppant, wherein after introduction of the treatment fluid: at least some of the first portion of proppant remains in the bottom portion of the fracture and at least some of the second portion of proppant remains in the top portion of the fracture; and the bottom portion of the fracture has a permeability that is less than the permeability of the top portion of the fracture.

### TECHNICAL FIELD

Hydraulic fracturing operations can be used to stimulate production of a reservoir fluid. Proppant is commonly placed within the fractures to prop the fracture open. A low permeability material can be placed in a bottom portion of the fracture, while a higher permeability material can be placed in a top portion of the fracture. A reservoir fluid can be more easily produced through the top portion of the fracture.

### BRIEF DESCRIPTION OF THE FIGURES

The features and advantages of certain embodiments will be more readily appreciated when considered in conjunction with the accompanying figures. The figures are not to be construed as limiting any of the preferred embodiments.

FIG. 1 is a diagram illustrating a fracturing system according to certain embodiments.

FIG. 2 is a diagram illustrating a well system in which a fracturing operation can be performed.

FIGS. 3A and 3B are side view and cross-sectional view illustrations, respectively, showing a fracture including a bottom portion and a top portion.

### DETAILED DESCRIPTION

Oil and gas hydrocarbons are naturally occurring in some subterranean formations. In the oil and gas industry, a subterranean formation containing oil or gas is referred to as a reservoir. A reservoir may be located under land or off shore. Reservoirs are typically located in the range of a few hundred feet (shallow reservoirs) to a few tens of thousands of feet (ultra-deep reservoirs). In order to produce oil or gas, a wellbore is drilled into a reservoir or adjacent to a reservoir. The oil, gas, or water produced from the wellbore is called a reservoir fluid.

As used herein, a “fluid” is a substance having a continuous phase that tends to flow and to conform to the outline of its container when the substance is tested at a temperature of 71° F. (22° C.) and a pressure of 1 atmosphere (atm) (0.1 megapascals (MPa)). A fluid can be a liquid or gas. A homogenous fluid has only one phase, whereas a heterogeneous fluid has more than one distinct phase. A heterogeneous fluid can be: a slurry, which includes an external liquid phase and undissolved solid particles as the internal phase; an emulsion, which includes an external liquid phase and at least one internal phase of immiscible liquid droplets; a foam, which includes an external liquid phase and a gas as the internal phase; or a mist, which includes an external gas phase and liquid droplets as the internal phase.

A well can include, without limitation, an oil, gas, or water production well, an injection well, or a geothermal well. As used herein, a “well” includes at least one wellbore. A wellbore can include vertical, inclined, and horizontal portions, and it can be straight, curved, or branched. As used herein, the term “wellbore” includes any cased, and any uncased, open-hole portion of the wellbore. A near-wellbore region is the subterranean material and rock of the subterranean formation surrounding the wellbore. As used herein, a “well” also includes the near-wellbore region. The near-wellbore region is generally considered the region within approximately 100 feet radially of the wellbore. As used herein, “into a well” means and includes into any portion of the well, including into the wellbore or into the near-wellbore region via the wellbore. As used herein, “into a subterranean formation” means and includes into any portion of a subterranean formation, including into a well, wellbore, or the near-wellbore region via the wellbore.

A portion of a wellbore may be an open hole or cased hole. In an open-hole wellbore portion, a tubing string may be placed into the wellbore. The tubing string allows fluids to be introduced into or flowed from a remote portion of the wellbore. In a cased-hole wellbore portion, a casing is placed into the wellbore that can also contain a tubing string. A wellbore can contain an annulus. Examples of an annulus include, but are not limited to: the space between the wellbore and the outside of a tubing string in an open-hole wellbore; the space between the wellbore and the outside of a casing in a cased-hole wellbore; and the space between the inside of a casing and the outside of a tubing string in a cased-hole wellbore.

After a wellbore is drilled, it may often be necessary to fracture the subterranean formation to enhance hydrocarbon production. A fracturing fluid, often called a pad fluid, is pumped using a frac pump at a sufficiently high flow rate and high pressure into the wellbore and into the subterranean formation to create or enhance a fracture in the subterranean formation. Creating a fracture means making a new fracture in the formation. Enhancing a fracture means enlarging a pre-existing fracture in the formation. As used herein, the term “fracture” means the creation or enhancement of a natural fracture using a fracturing fluid, and can be referred to as “man-made.” To fracture a subterranean formation typically requires hundreds of thousands of gallons of fracturing fluid. Further, it is often desirable to fracture at more than one downhole location. Therefore, the base fluid of a fracturing fluid is usually water or water-based for various reasons, including the ready availability of water and the relatively low cost of water compared to other liquids.

The newly-created or enhanced fracture will tend to close together after pumping of the fracturing fluid has stopped due to the weight of the subterranean formation. To prevent the fracture from closing, a material must be placed in the fracture to keep the fracture propped open. A material used for this purpose is often referred to as a “proppant.” The proppant is in the form of solid particles, which can be suspended in the fracturing fluid, carried down hole, and deposited in the fracture as a “proppant pack.” The proppant pack generally props the fracture in an open position while allowing fluid flow through the permeability of the pack.

Proppant materials generally include silicon dioxide, walnut shells, sintered bauxite, glass, plastics, metals, ceramic materials, and any combination thereof in any proportion. The proppant is an appropriate size to prop open the fracture and allow fluid to flow through the proppant pack, that is, in between and around the proppant making up the pack. Appropriate sizes of particulate for use as a proppant are typically in the range from about 5 to about 100 U.S. Standard Mesh. A typical proppant is sand-sized, which geologically is defined as having a largest dimension ranging from 0.0625 millimeters up to 3 millimeters.

The subterranean formation will exert a force or pressure on the proppant located within the fracture. This is known as the closure stress of the formation or fracture. The proppant is generally sufficiently strong, that is, have a sufficient compressive or crush resistance, to prop the fracture open without being deformed or crushed by the closure stress of the fracture. Pressures from the subterranean formation on the proppant located in the fractures can be as high as 10,000 to generally 15,000 or more pounds force per square inch (psi). If a proppant material crushes under closure stress, then the fracture will close and no longer function to provide a less restrictive fluid flow path for production of reservoir fluids. Crush resistance is a term commonly used to denote the strength of a proppant and may be determined using API 19C. A strong proppant generates a lower weight percent crushed proppant than a weak proppant at the same closure stress. For example, under the same test conditions, a proppant that has a 2 weight percent crushed proppant is considered to be a strong proppant and is commonly preferred to a weak proppant that has a 10 weight percent crushed proppant. As such, proppant generally has a crush resistance measured as less than about 5 to 10 weight percent of the proppant crushes under the closure stress of the formation. Accordingly, about 90 to 95 weight percent of the proppant does not crush under the closure stress and functions to keep the fracture in an open position. The proppant must generally be a high-quality proppant and the size and shape of the proppant selected to provide the desired weight percentage of crushing.

The conductivity of the fracture (i.e., the flow rate of fluid through the fracture) and the duration of the conductivity is related to the quality of the proppant, the size of the proppant, and the placement of the proppant within the fracture. In order to increase the conductivity and conductivity life, higher-quality proppant is commonly used. Moreover, the same amount of permeability throughout the entire fracture is desired. For example, the proppant is ideally placed within the fracture such that the top part of the fracture has approximately the same amount of permeability as the bottom part of the fracture. As a result, proppant pack operations are commonly designed to provide a relatively uniform distribution of proppant to form the proppant pack. This means that large quantities of proppant may need to be used to provide the uniform permeability via placement of the proppant, which can be quite costly. Thus, there is a need and on-going industry wide interest in methods of producing a reservoir fluid through a fracture.

It has been discovered that the conductivity of a fracture can be increased by forming a bottom portion of the fracture with a very low to no permeability and a top portion with a higher permeability compared to the bottom portion. For a fracture having the same dimensions, the novel methods increase the conductivity and/or the conductivity life of the fracture compared to conventional methods. One of the main differences between the novel methods and conventional techniques is that the novel methods produce a bottom portion having little to no permeability, unlike conventional methods that desire a higher permeability in all areas of the fracture. Additionally, lower-quality proppant and a lower quantity can be used, which can reduce costs.

According to certain embodiments, a method of fracturing a subterranean formation comprises: introducing a fracturing fluid into the subterranean formation, wherein the introduction of the fracturing fluid creates or enhances a fracture in the subterranean formation, and wherein the fracture comprises a bottom portion and a top portion; and introducing a treatment fluid into the fracture after introduction of the fracturing fluid, wherein the treatment fluid comprises: (A) a base fluid; and (B) proppant, wherein a first portion of the proppant has a property that is different from a second portion of the proppant, wherein after introduction of the treatment fluid: at least some of the first portion of proppant remains in the bottom portion of the fracture and at least some of the second portion of proppant remains in the top portion of the fracture; and the bottom portion of the fracture has a permeability that is less than the permeability of the top portion of the fracture.

According to certain other embodiments, a method of fracturing a subterranean formation comprises: introducing a fracturing fluid into the subterranean formation, wherein the introduction of the fracturing fluid creates or enhances a fracture in the subterranean formation, and wherein the fracture comprises a bottom portion and a top portion; and simultaneously introducing a first and second treatment fluid into the fracture, wherein the first and second treatment fluids comingle prior to or as the first and second treatment fluids enter the fracture, and wherein the first and second treatment fluids are introduced after introduction of the fracturing fluid, wherein after introduction of the first and second treatment fluids: at least a portion of the first treatment fluid remains in the bottom portion of the fracture and at least a portion of the second treatment fluid remains in the top portion of the fracture; and the bottom portion of the fracture has a permeability that is less than the permeability of the top portion of the fracture.

The discussion of preferred embodiments regarding the treatment fluids or any ingredient in the treatment fluids is intended to apply to all of the method embodiments. Any reference to the unit “gallons” means U.S. gallons.

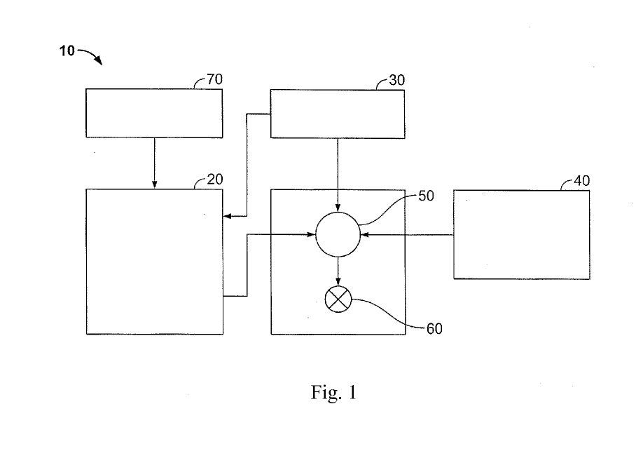

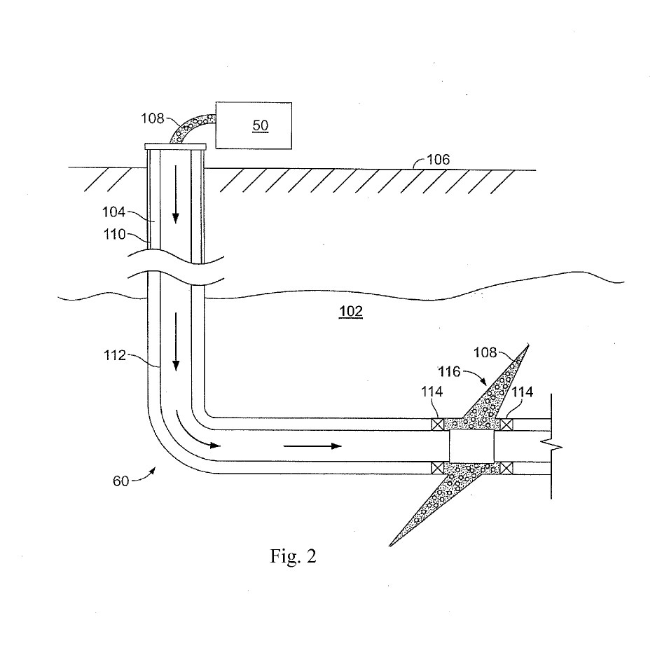

The following discussion related to FIGS. 1 and 2 pertains to any of the fluids (i.e., the fracturing fluid and the treatment fluids). It should be understood that any discussion related to a “fracturing fluid” is meant to include any of the treatment fluids without the need to continually refer to all of the different types of fluids throughout. The fracturing system 10 of FIG. 1 can include a fluid-producing apparatus 20, a fluid source 30, a proppant source 40, and a pump and blender system 50 and resides at the surface at a well site where a well 60 is located. In certain embodiments, the fluid producing apparatus 20 combines a gel precursor with fluid (e.g., liquid or substantially liquid) from fluid source 30, to produce a hydrated fluid that is introduced into the subterranean formation. The hydrated fluid can be a fluid for ready use in a fracture stimulation treatment of the well 60 or a concentrate to which additional fluid is added prior to use in a fracture stimulation of the well 60. In other instances, the fluid-producing apparatus 20 can be omitted and the fluid sourced directly from the fluid source 30.

The proppant source 40 can include a proppant (including micro-proppant) for combining with the fluid. The system may also include an additive source 70 that provides one or more additives (e.g., gelling agents, weighting agents, and/or other optional additives) to alter the properties of the fluid. This source can also have a hopper for on the fly coating of the proppant with the coating, or this source can be used to introduce pre-treated or pre-cured resin coated proppant into a treatment fluid.

The pump and blender system 50 can receive the fluid and combine it with other components, including proppant from the proppant source 40 and/or additional fluid from the additives 70. The resulting mixture may be pumped down the well 60 under a pressure sufficient to create or enhance one or more fractures in a subterranean zone, for example, to stimulate production of fluids from the zone. The fluid-producing apparatus 20, fluid source 30, and/or proppant source 40 can each be equipped with one or more metering devices (not shown) to control the flow of fluids, proppant, and/or other compositions to the pumping and blender system 50. Such metering devices can facilitate the pumping. The blender system 50 can source from one, some, or all of the different sources at a given time, and can facilitate the preparation of fracturing fluids using continuous mixing or “on-the-fly” methods. Thus, for example, the pumping and blender system 50 can provide just fracturing fluid into the well at some times, just proppant at other times, and combinations of those components at yet other times.

The fluid can be pumped into the subterranean formation. FIG. 2 shows the well 60 during a fracturing operation in a portion of a subterranean formation 102. The subterranean formation can be penetrated by a well. The well can be, without limitation, an oil, gas, or water production well, an injection well, or a geothermal well. The well can also be an offshore well. The well includes a wellbore 104. The wellbore 104 extends from the surface 106, and a fracturing fluid 108 is introduced into a portion of the subterranean formation 102. The wellbore 104 can include a casing 110 that is cemented or otherwise secured to the wellbore wall. The wellbore 104 can be uncased or include uncased sections. Perforations can be formed in the casing 110 to allow fracturing fluids and/or other materials to flow into the subterranean formation 102. In cased wells, perforations can be formed using shaped charges, a perforating gun, hydro-jetting and/or other tools.

The well is shown with a work string 112. The pump and blender system 50 can be coupled to the work string 112 to pump the fracturing fluid 108 into the wellbore 104. The work string 112 can include coiled tubing, jointed pipe, and/or other structures that allow fluid to flow into the wellbore 104. The work string 112 can include flow control devices, bypass valves, ports, and or other tools or well devices that control a flow of fluid from the interior of the work string 112 into the subterranean formation 102. For example, the work string 112 can include ports (not shown) located adjacent to the wellbore wall to communicate the fracturing fluid 108 directly into the subterranean formation 102, and/or the work string 112 can include ports that are spaced apart from the wellbore wall to communicate the fracturing fluid 108 into an annulus that is located between the outside of the work string 112 and the wall of the wellbore.

The well system can include one or more sets of packers 114 that create one or more wellbore intervals. The methods also include creating or enhancing one or more fractures within the subterranean formation using the fracturing fluid or the first treatment fluid. When the fracturing fluid 108 or the first treatment fluid is introduced into wellbore 104 (e.g., in FIG. 2, the wellbore interval located between the packers 114) at a sufficient hydraulic pressure, one or more fractures 116 can be created in the subterranean formation 102.

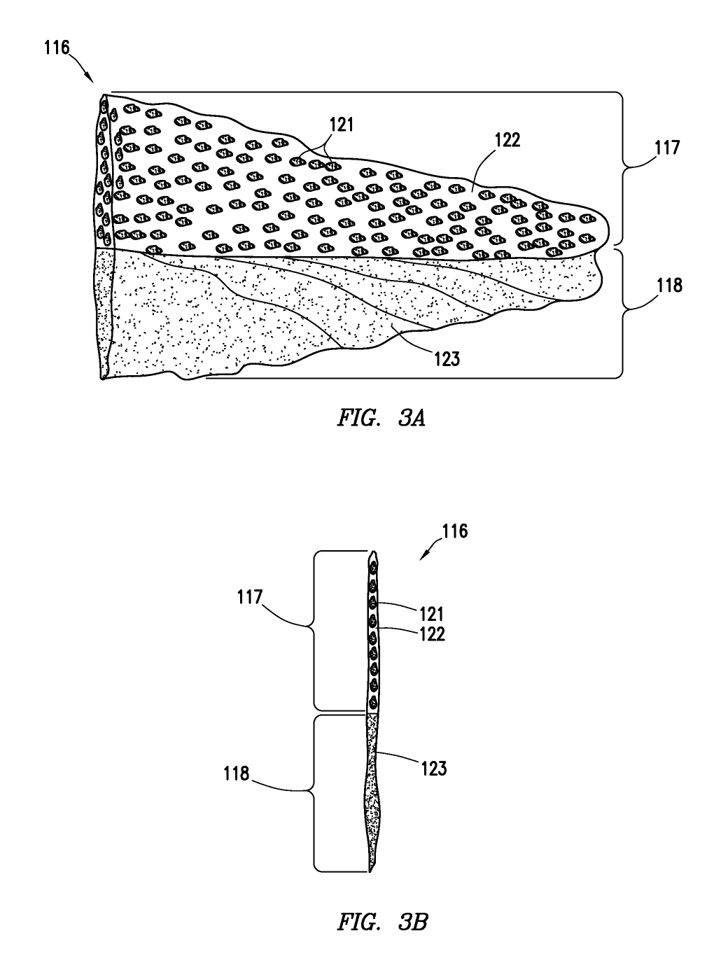

As can be seen in FIGS. 3A and 3B, the fracture 116 includes a bottom portion 118 and a top portion 117. The fracture can also include a middle portion (not shown) as well as other portions not specifically disclosed. The bottom portion 118 and the top portion 117 do not have to have the same dimensions or area. By way of example, the height of the bottom portion can be greater than the height of the top portion. Moreover, the length of the bottom and top portions can be the same or different. The volume of the bottom and top portions can also be the same or different. It should be understood that the bottom portion and the top portion can be partially defined by the first portion and second portion of proppant or the portion of the first and second treatment fluids that remain in the bottom and top portion of the fracture. It should also be understood that the relative terms “bottom” and “top” are used herein for convenience and are defined as the bottom portion being located farther away from the earth's surface compared to the top portion.

The fracturing fluid and any of the treatment fluids can include a base fluid. As used herein, the term “base fluid” means the liquid that is in the greatest concentration and is the solvent of a solution or the continuous phase of a heterogeneous fluid. The base fluid can include water. The water can be selected from the group consisting of fresh water, brackish water, sea water, brine, produced water—as it is or processed, and any combination thereof in any proportion. The fracturing fluid and any of the treatment fluids can also include water-miscible liquids, hydrocarbon liquids, and gases.

The fracturing fluid and any of the treatment fluids can also contain various other additives. The other additives can include, for example, silica scale control additives, surfactants, gel stabilizers, anti-oxidants, polymer degradation prevention additives, relative permeability modifiers, scale inhibitors, corrosion inhibitors, foaming agents, defoaming agents, antifoaming agents, emulsifying agents, de-emulsifying agents, iron control agents, particulate diverters, salts, acids, fluid loss control additives, gas, catalysts, clay control agents, dispersants, flocculants, scavengers (e.g., H₂S scavengers, CO₂ scavengers, or O₂ scavengers), gelling agents, lubricants, breakers, friction reducers, bridging agents, viscosifiers, weighting agents, solubilizers, pH control agents (e.g., buffers), hydrate inhibitors, consolidating agents, bactericides, catalysts, clay stabilizers, breakers, and delayed release breakers.

According to certain embodiments, a treatment fluid is introduced into the fracture after introduction of the fracturing fluid. The treatment fluid includes the base fluid and proppant. A first portion of the proppant has a property that is different from a second portion of the proppant. According to certain embodiments, the property is specific gravity. The first portion of the proppant can have a higher specific gravity compared to the second portion of the proppant. The difference in specific gravity can be at least an absolute value of 0.3. The first portion of the proppant can have a specific gravity in the range of about 2.4 to about 4.0. The second portion of the proppant can have a specific gravity in the range of about 1.0 to about 2.7. The viscosity of the treatment fluid may also need to be adjusted to allow the first portion of the proppant, having a higher specific gravity, to settle to the bottom portion of the fracture. As such, the viscosity of the treatment fluid may need to be less than a viscosity that is commonly used in traditional proppant carrier fluids. Moreover, the use of a suspending agent may not be desirable for this embodiment.

According to certain other embodiments, the property is the weight percent of crushed proppant. According to these embodiments, the first portion of the proppant can have a higher weight percent of crushing compared to the second portion of the proppant. By way of example, the first portion of the proppant can have a weight percent of crushing in the range of 30% to about 95%, which means that about 30% to 95% by weight of the first portion of the proppant crushes under the closure stress of the formation. The second portion of the proppant can have a weight percent of crushing in the range of about 5% to about 30%, which means that only about 5% to about 30% by weight of the second portion of the proppant crushes under the closure stress of the formation.

According to certain other embodiments, the property is the particle size. As used herein, the term “particle size” refers to the volume surface mean diameter (“Dₛ”), which is related to the specific surface area of the particle. The volume surface mean diameter may be defined by the following equation: Dₛ=6/(ΦₛA_{w}ρₚ), where Φₛ=sphericity; A_{W}=specific surface area; and ρₚ =particle density. The first portion of the proppant can have a larger particle size compared to the second portion of the proppant. The difference in particle size can be at least 50 micrometers, 100 micrometers, or 200 micrometers. The first portion of the proppant can settle more easily to the bottom portion of the fracture 118 due to the larger particle size; thus, allowing the second portion of the proppant to remain in the top portion of the fracture 117. The viscosity of the treatment fluid can be selected to facilitate the settling of the larger first portion of the proppant. According to these embodiments, the first portion of the proppant and the second portion of the proppant can be selected from the same or different types of materials.

According to certain other embodiments, the property is hydrophobicity. According to these embodiments, the first portion of the proppant can have a surface that is water wet, whereas the second portion of the proppant can have a surface that is oil wet. The surface of the first portion of the proppant and/or second portion of the proppant can be chemically modified to produce the desired amount of hydrophobicity and wettability. By way of example, the second portion of the proppant can be hydrophobically modified to produce a surface that is oil wet. According to this embodiment, the type of material making up the proppant can be the same (e.g., both the first and second portion of proppant is sand) so long as the surfaces of the first and second portions have a different hydrophobicity. The base fluid for this embodiment can include an aqueous liquid, a hydrocarbon liquid, or combinations thereof (i.e., an emulsion or invert emulsion). For an emulsion or an invert emulsion, the base fluid can also include a surfactant. The first portion of the proppant can form micelles in an aqueous-based fluid and the second portion of the proppant can form reverse-micelles in a hydrocarbon-liquid-based fluid.

According to certain other embodiments, the first portion of the proppant has two or more properties that are different from the second portion of the proppant. By way of example, the weight percent of crushing may be dependent on the particle size of the first and second portions of proppant. Thus, the two or more properties can be particle size and the weight percent of crushing. Accordingly, the larger particle sized first portion of the proppant may have a higher weight percent of crushed proppant compared to the second portion of proppant. In this manner, the first portion of the proppant can settle to the bottom portion of the fracture and then crush under the closure stress of the subterranean formation to provide a reduced permeability in the bottom portion of the fracture.

The first portion and second portion of the proppant can be selected from the group consisting of sand; natural sand; quartz sand; particulate garnet; metal particulates; aluminum oxide; bauxite; bauxitic clay; kaolin; alumino-silicates; dolomite; limestone; iron oxide, and other ores or minerals; cement; cement composites; glass bubbles, available from 3M in St. Paul, Minn.; nut shells; ceramics; glass; nylon pellets; polymeric materials; polymer composites containing particulate materials, such as nanoparticles; porous ceramics; porous organic materials; porous metals; and combinations thereof. The type of material that the first and second portions of the proppant are selected from can be dependent on the desired property difference. The proppant can be substantially or partially spherical in shape, substantially or partially round in shape, fibrous materials, polygonal shaped (such as cubic), irregular shapes, and any combination thereof.

The proppant can be in a concentration in the range of about 1% to about 60% by weight of the base fluid. The ratio of the first portion of the proppant to the second portion of the proppant can be in the range of about 1:1 to about 1:4.

After introduction of the treatment fluid, at least some of the first portion of the proppant 123 remains in the bottom portion 118 of the fracture 116 and at least some of the second portion of the proppant 121 remains in the top portion 117 of the fracture 116. The first portion of the proppant can settle or remain within the fracture to at least partially define the bottom portion of the fracture and can be due to the difference in specific gravity, crush resistance, or hydrophobicity of the first and second portions of proppant. According to certain embodiments, the difference in the property of the first and second portions of the proppant causes the first portion of the proppant to become separated from the second portion of the proppant.

After introduction of the treatment fluid, the bottom portion of the fracture has a permeability that is less than the permeability of the top portion of the fracture. When a single treatment fluid is introduced into the fracture, then the difference in the property of the first and second portions of proppant should be selected to not only allow at least some of the first portion of the proppant to remain in the bottom portion and at least some of the second portion of the proppant to remain in the top portion, but also to allow the bottom portion to have a permeability that is less than the top portion. By way of example, the difference in specific gravity can be selected such that the first portion of the proppant settles within the fracture while the second portion of the proppant can remain in the top portion of the fracture to provide the decreased permeability in the bottom and top portions of the fracture.

According to certain other embodiments, a first and second treatment fluid are introduced into the fracture after introduction of the fracturing fluid. The first and second treatment fluids comingle prior to or as the first and second treatment fluids enter the fracture. By way of example, the first treatment fluid can be introduced through a coiled tubing while the second treatment fluid can be introduced through an annulus between the outside of a tubing string and the inside of a casing or wall of the wellbore. The fluids can then come together and comingle to form a single fluid that enters the fracture.

At least a portion of the first treatment fluid 123 remains in the bottom portion of the fracture and at least a portion of the second treatment fluid 121/122 remains in the top portion of the fracture. The first treatment fluid can be an aqueous liquid or an emulsion containing non-hydrophobically modified proppant (i.e., water-wet proppant). The second treatment fluid can be an invert emulsion containing hydrophobically modified proppant (i.e., oil-wet proppant).

The first treatment fluid can also have a higher density compared to the second treatment fluid. According to these embodiments, the first treatment fluid can be a non-foamed fluid or a fluid containing a water-soluble salt. The second treatment fluid can be a foamed fluid or a fluid that does not contain a water-soluble salt. Accordingly, the first treatment fluid, having a higher density, can remain in the bottom portion of the fracture, while the second treatment fluid, having a lower density, can remain in the top portion of the fracture. The first and second treatment fluids having a different density can contain proppant. According to these embodiments, the proppant can be the same (i.e., have the same properties). Of course, the proppant can also have different properties, but it should be understood that it is the difference in density of the first and second treatment fluids that allow the fluids to remain in the bottom and top portions of the fracture and not a difference in a property of the proppant.

Any of the proppant can be coated with a curable resin or tackifying agent. The curable resin or tackifying agent can cause the proppant that remains in the bottom and top portions from undesirably becoming dislodged from the fracture. The curable resin can be part of a curing resin system. The curable resin can be any compound that is capable of curing (i.e., the process of gaining compressive strength and becoming hard). Preferably, the curable resin cures via a chemical reaction with a curing agent. The curable resin can coat the proppant prior to or during introduction of any of the treatment fluids into the fracture. The curable resin can also chemically bond with the surfaces of the proppant. According to certain embodiments, the curable resin is an epoxy, diepoxy, polyepoxy resin, phenol-formaldehyde, or furan based resin. For example, the curable resin can be bisphenol A glycidyldiepoxy, glycidyl propyltrimethoxysilane. The curable resin can be in a concentration in the range of about 0.1% to about 10% weight by weight of the resin system.

The methods can further include introducing a breaker for breaking the viscosity or gel of any of the treatment fluids that have a high viscosity. The breaker can be introduced after the introduction of the treatment fluids. The breaker can reduce the viscosity of the treatment fluids such that the base fluid can flow from the fracture and into the wellbore or subterranean formation. The breaker can be selected from the group consisting of enzyme breakers, oxidizers (including at least one member selected from the group consisting of ammonium; sodium or potassium perfsulfate; sodium peroxide; sodium chlorite; sodium, lithium or calcium hypochlorite; chlorinate lime; potassium perphosphate; sodium perborate; magnesium monoperoxyphthalate hexahydrate; organic chlorine derivatives such a N,N′-dichloro dimethyl hydantion and N-chlorocyanuric acid and salts thereof), chitosan, metal bromate, calcium oxide, calcium hydroxide, sodium carbonate, an amine, an acid, or a peroxide. The breaker can also be provided as an encapsulated compound. According to certain embodiments, after the treatment fluid(s) are broken, the proppant can remain in the bottom and/or top portion of the fracture. During and after the fluids are broken, the closure stress from the formation can help keep the particles or particle aggregates within the bottom and/or top portion of the fracture.

A curing agent can also be introduced into the fracture. The curing agent can be included within any of the treatment fluids. The curing agent can also be introduced after the introduction of the treatment fluids. The curing agent can be introduced with a fluid that also includes the breaker. The curing agent can cause the curable resin to cure. The curing agent can be a dimer acid, a dimer diamine, or a trimer acid.

The curing agent can be in a concentration in the range of about 0.1% to about 60% weight by weight of the resin system. The curing agent can also be in a ratio of about 1:10 to about 10:1 by volume of the curable resin. Of course, the curable resin can cure via heat, in which case, it may not be necessary to introduce a curing agent.

After introduction of the treatment fluid and after introduction of the first and second treatment fluids, the bottom portion of the fracture has a permeability that is less than the permeability of the top portion of the fracture. As used herein, the phrase “less than” means a value that is at least 20% less than another value. According to certain embodiments, the permeability of the bottom portion of the fracture is less than 10 darcy (9.9 micrometers²). According to certain other embodiments, the permeability of the bottom portion of the fracture is 0. The permeability of the top portion of the fracture can be greater than 13 darcy (12.8 micrometers²). According to certain embodiments, the permeability of the bottom portion of the fracture is at least 50% less than the permeability of the top portion of the fracture. As can be seen in FIGS. 3A and 3B, highly-permeable channels 122 can exist within the top portion 117 of the fracture 116. These highly-permeably channels can increase the permeability and flow rate of a fluid through the top portion of the fracture.

Using Darcy's law, a higher flow rate through the top portion of the fracture can be obtained by creating the highly-permeable channels and a negligible permeability in the bottom portion compared to traditional proppant packs. This higher flow rate can also be accomplished even when the bottom portion of the fracture comprises 50% to 80% of the total fracture area. Traditionally, it has been thought that forming a conventional proppant pack in the entire fracture was needed to establish desirable fluid flow rates through the fracture. However, the embodiments disclosed herein provide equivalent flow rates compared to traditional proppant packs with a significantly less (e.g., 1/120) height and holding fracture length and width constant. As such, a traditional proppant packed fracture would require a height of 120 inches; whereas, the embodiments disclosed herein would have the same flow rate when the top portion of the fracture had a height of only 1 inch. The methods disclosed herein can also increase the conductivity life of the fracture.

The exemplary fluids and additives disclosed herein may directly or indirectly affect one or more components or pieces of equipment associated with the preparation, delivery, recapture, recycling, reuse, and/or disposal of the disclosed fluids and additives. For example, the disclosed fluids and additives may directly or indirectly affect one or more mixers, related mixing equipment, mud pits, storage facilities or units, fluid separators, heat exchangers, sensors, gauges, pumps, compressors, and the like used generate, store, monitor, regulate, and/or recondition the exemplary fluids and additives. The disclosed fluids and additives may also directly or indirectly affect any transport or delivery equipment used to convey the fluids and additives to a well site or downhole such as, for example, any transport vessels, conduits, pipelines, trucks, tubulars, and/or pipes used to fluidically move the fluids and additives from one location to another, any pumps, compressors, or motors (e.g., topside or downhole) used to drive the fluids and additives into motion, any valves or related joints used to regulate the pressure or flow rate of the fluids, and any sensors (i.e., pressure and temperature), gauges, and/or combinations thereof, and the like. The disclosed fluids and additives may also directly or indirectly affect the various downhole equipment and tools that may come into contact with the fluids and additives such as, but not limited to, drill string, coiled tubing, drill pipe, drill collars, mud motors, downhole motors and/or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention.

As used herein, the words “comprise,” “have,” “include,” and all grammatical variations thereof are each intended to have an open, non-limiting meaning that does not exclude additional elements or steps. While compositions and methods are described in terms of “comprising,” “containing,” or “including” various components or steps, the compositions and methods also can “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

What is claimed is:

1. A method of fracturing a subterranean formation comprising:
introducing a fracturing fluid into a fracture in the subterranean formation, wherein the fracture comprises a bottom portion and a top portion; and
introducing a treatment fluid into the fracture after introduction of the fracturing fluid, wherein the treatment fluid comprises:
A) a base fluid; and
B) proppant, wherein a first portion of the proppant has a property that is different from a second portion of the proppant,
wherein after introduction of the treatment fluid: at least some of the first portion of proppant remains in the bottom portion of the fracture and at least some of the second portion of proppant remains in the top portion of the fracture; and the bottom portion of the fracture has a permeability that is less than the permeability of the top portion of the fracture.

2. The method according to claim 1, wherein the property is specific gravity.

3. The method according to claim 2, wherein the first portion of the proppant has a higher specific gravity compared to the second portion of the proppant.

4. The method according to claim 3, wherein the difference in specific gravity is an absolute value of at least 0.3.

5. The method according to claim 3, wherein the viscosity of the treatment fluid is selected such that the first portion of the proppant settles to the bottom portion of the fracture.

6. The method according to claim 1, wherein the property is the weight percent of crushing of the first portion of the proppant and the second portion of the proppant.

7. The method according to claim 6, wherein the first portion of the proppant has a higher weight percent of crushing compared to the second portion of the proppant.

8. The method according to claim 7, wherein the first portion of the proppant has a weight percent of crushing in the range of 30% to about 95%, and the second portion of the proppant has a weight percent of crushing in the range of about 5% to about 30%.

9. The method according to claim 1, wherein the property is particle size.

10. The method according to claim 9, wherein the first portion of the proppant has a larger particle size compared to the second portion of the proppant, and wherein the difference in particle size is at least about 50 micrometers.

11. The method according to claim 1, wherein the property is hydrophobicity.

12. The method according to claim 11, wherein the first portion of the proppant has a surface that is water wet and the second portion of the proppant has a surface that is oil wet.

13. The method according to claim 12, wherein the second portion of the proppant is hydrophobically modified to produce the surface that is oil wet.

14. The method according to claim 11, wherein the base fluid is an emulsion or invert emulsion.

15. The method according to claim 1, wherein the first portion of the proppant has two or more properties that are different from the second portion of the proppant, and wherein the two or more properties are selected from particle size and weight percent of crushing.

16. The method according to claim 1, wherein the first portion and second portion of the proppant is selected from the group consisting of sand; natural sand; quartz sand; particulate garnet; metal particulates; aluminum oxide; bauxite; bauxitic clay; kaolin; alumino-silicates; dolomite; limestone; iron oxide, and other ores or minerals; cement; cement composites; glass bubbles; nut shells; ceramics; glass; nylon pellets; polymeric materials; polymer composites containing particulate materials; porous ceramics; porous organic materials; porous metals; and combinations thereof.

17. The method according to claim 1, wherein the permeability of the bottom portion of the fracture is less than about 10 darcy and the permeability of the top portion of the fracture is greater than about 13 darcy.

18. The method according to claim 1, wherein the permeability of the bottom portion of the fracture is at least about 50% less than the permeability of the top portion of the fracture.

19. The method according to claim 1, wherein the fracturing fluid and treatment fluid are introduced into the subterranean formation using one or more pumps.

20. A method of fracturing a subterranean formation comprising:
introducing a fracturing fluid into a fracture in the subterranean formation, wherein the fracture comprises a bottom portion and a top portion; and
simultaneously introducing a first and second treatment fluid into the fracture, wherein the first and second treatment fluids comingle prior to or as the first and second treatment fluids enter the fracture, and wherein the first and second treatment fluids are introduced after introduction of the fracturing fluid,
wherein after introduction of the first and second treatment fluids: at least a portion of the first treatment fluid remains in the bottom portion of the fracture and at least a portion of the second treatment fluid remains in the top portion of the fracture; and the bottom portion of the fracture has a permeability that is less than the permeability of the top portion of the fracture.

21. The method according to claim 20, wherein the first treatment fluid comprises an aqueous liquid or an emulsion, and further comprising a non-hydrophobically modified proppant.

22. The method according to claim 21, wherein the second treatment fluid comprises an invert emulsion, and further comprising a hydrophobically modified proppant.

23. The method according to claim 20, wherein the first treatment fluid has a higher density compared to the second treatment fluid.

24. The method according to claim 23, wherein the first treatment fluid is a non-foamed fluid or a fluid containing a water-soluble salt, and wherein the second treatment fluid is a foamed fluid or a fluid that does not contain a water-soluble salt.

25. The method according to claim 24, wherein the first and second treatment fluids further comprise proppant.

26. The method according to claim 20, wherein the permeability of the bottom portion of the fracture is less than about 10 darcy and the permeability of the top portion of the fracture is greater than about 13 darcy.

27. The method according to claim 20, wherein the permeability of the bottom portion of the fracture is at least about 50% less than the permeability of the top portion of the fracture.

28. The method according to claim 20, wherein the fracturing fluid and treatment fluid are introduced into the subterranean formation using one or more pumps.
